(19) United States
(12) Patent Application Publication
(10) Pub. No.: US 2026/0218991 A1
(43) Pub. Date: Jul. 30, 2026

(54) SYSTEM AND METHOD FOR ENERGY STORAGE

(71) Applicant: OASIX ENERGY LTD., Tel Aviv (IL)

(72) Inventors: Jonathan HARAN, Tel Aviv (IL); Dan SAGIE, Beer-Sheva (IL); Moshe TSHUVA, Tel Aviv (IL)

(21) Appl. No.: 19/384,037

(22) Filed: Nov. 10, 2025

Related U.S. Application Data
(63) Continuation-in-part of application No. PCT/IL2024/051159, filed on Dec. 5, 2024.
(60) Provisional application No. 63/606,237, filed on Dec. 5, 2023.

(51) Int. Cl. F28D 20/02; F28D 20/00; F28D 21/00

(52) U.S. Cl. CPC F28D 20/025; F28D 20/028; F28D 2020/0078; F28D 2020/0082; F28D 2021/007; F28D 2021/0071

(57) ABSTRACT

A thermal energy storage system is disclosed for dual storage of thermal energy, optionally implemented with a heat pump or equivalent temperature-gradient generator

### RELATED APPLICATIONS

This application claims priority to U.S. Provisional Patent Application No. 63/606,237, entitled “Heat Pump and System Implementing Same,” filed Dec. 5, 2023, the contents of which are hereby incorporated by reference as if fully set forth herein.

### TECHNOLOGICAL FIELD

The present disclosure relates to the field of energy management, and more specifically, but not exclusively, to a heat pump with storage tanks for dual storage of thermal energy.

### BACKGROUND OF THE INVENTION

Homes, offices, and other real-estate facilities need both cooling power for air conditioning and heating power for showers, heaters, and other thermal comfort devices. Homeowners and businesses strive to supply their thermal needs based on the following considerations:
Cost-effective and reliable devices that provide basic needs for many years at a good cost.
Energy security: gas prices rise from time to time. Blackouts from wildfires and other events have become more frequent in California and Europe. Energy security and continuity is important for comfort but also for survival during very cold or hot weather events.
Emissions: many countries, as well as individual consumers, have set a target to reduce carbon-emissions to zero by 2050.

A heat pump is a device that consumes energy (usually electricity) to transfer heat from a cold heat sink to a hot heat sink. Specifically, the heat pump transfers thermal energy using a refrigeration cycle. In cold weather, a heat pump can move heat from the cool outdoors to warm a house (e.g., winter); the pump may also be designed to cool homes, moving heat from the home to the warm outdoors in warm weather (e.g., summer).

Many types of heat pumps are currently used, with different levels of efficiency. The most common heat pumps are used in residential applications and are configured as air-air, meaning that they draw heat from the air and augment it to provide it to a consumer via a fan coil which uses air to distribute the heat. Geothermal heat pumps are more efficient than air-air heat pumps due to the substantially constant temperature of the earth. However, unlike the air-air systems, their installation is complex and requires drilling. Also, they cannot be moved after installation. Water-water heat pumps are also more efficient than air-air, thanks to the high heat transfer coefficient of water, but require a large enough water tank such as a lake to supply the heat in a regenerative manner that will be sufficient for year-round use. Solar-assisted heat pumps are air-air heat pumps that use solar power as their power source and otherwise are quite similar to air-air ones. Their use reduces emissions, but they are not designed to operate only on solar power, therefore they are either polluting (but less) or not energy security compliant.

The efficiency of a heat pump is expressed as a coefficient of performance (COP): The ratio of useful heating or cooling provided vs. work (energy) invested. Higher COPs equate to higher efficiency, lower energy consumption, and thus lower operating costs. The currently accepted values for COP, for both heating and cooling, are COP >3.

Notwithstanding the type of heat pump, heat pumps have various limitations. Heat pumps are expensive due to the oversizing of components such as compressors, which are designed to operate on the coldest day of the year. Furthermore, not all heat pumps are capable of storing heat or cold; and most cannot store the whole thermal daily load. As a result, use of heat or cooling requires consumption during peak hours, thereby requiring incurring high costs while creating grid congestion. Heat pumps are only efficient to a certain extent (COP 3), while emitting about 50% waste heat or cold which in most cases is not economical nor practical to recover. This not only results in energy and financial losses, but also in space, or footprint, inefficiencies which are significant where real-estate is expensive. Heat pumps do not offer energy security. In blackouts or extreme weather events heating or cooling can be life savings, but without electricity, they cannot be operated.

A phase change material is a substance which releases or absorbs sufficient energy at phase transition to provide useful heat or cooling. Generally, the transition is between the solid state and the liquid state. At the phase transition temperature, the heat storage or release of the phase change material is considered “latent,” as opposed to “sensible.” Examples of phase change materials that exhibit such characteristics at temperatures between 5° C. and 60° C. include hydrates of certain salts.

### SUMMARY OF THE INVENTION

The present disclosure introduces an efficient design of a system, herein referred to as a thermal energy storage system, including subsystem that generates heat and cold thermal energy e.g. heat pump. A typical heat pump may be regarded a thermal energy storage system, namely a device that combines an ability to store and transfer thermal energy i.e., heat, from a cold heat sink to a hot heat sink. Specifically, the heat pump transfers thermal energy using a refrigeration cycle. In cold weather, a heat pump can move heat from the cool outdoors to warm a house (e.g., winter); the pump may also be designed to move heat from the home to the warm outdoors in warm weather (e.g., summer).

The thermal energy storage system, implementing a heat pump of the invention incorporates at least two thermal storage tanks, each designed to store energy in a form of thermal energy, wherein each of the thermal storage tanks is maintained at different temperatures. The at least two thermal storage tanks include at least one high temperature tank and at least one low temperature tank. Both the high and low temperature tanks are charged, simultaneously, by operation of the heat pump, with the stored energy being available for later uses. These later uses may include, inert alia, for the high temperature storage, heating of water, and for the low temperature storage, cooling of an interior environment. Both the high temperature tank and the low temperature tank are built directly into the cycle of the system.

The system of the present invention differs from known thermal energy generation systems in that traditional thermal energy generation systems, such as heat pumps use external (large) high/low temperature reservoirs as their hot/cold source (geothermal, air, lake etc.), but do not use the finite-size thermal storage tanks as the heat source itself. Therefore, they cannot be considered as stand-alone or closed-loop and are always dependent on the regeneration of the external hot/cold source. The proposed system is configured to charge the hot and cold tanks, rather than an external source.

A system of the invention may be operated in a closed loop or an open loop. When the system is operated in a closed loop manner, the sources of energy for the system are confined to the high temperature and the low temperature tanks themselves, so that the heat is drawn from one tank to the other. In such a case, one tank is heated while the other is cooled, effectively creating a thermal gradient between the two tanks. This configuration provides maximum efficiency but may be more limited in application. When the system is operated in an open loop manner, one of the tanks is heated or cooled, and the system uses an external energy reservoir (such as air) as a heat source. Then, only one of the low temperature or high temperature storage tanks may be charged or discharged at a time, while the other is temporarily bypassed. This configuration allows for the system to be charged and discharged under more varied circumstances. For example, if the high temperature tank has reached its maximum heat, but it is still desired to reduce the temperature in the low temperature tank, heat may instead be rejected to the ambient environment.

The option to operate in an open loop manner may be utilized also to generate flexible storage capacity. In flexible storage capacity, some tanks, which are designed for latent heat transfer within a particular temperature range, may be used for sensible heat transfer in a different temperature range. As a result, these tanks may be temporarily repurposed to achieve a different type of storage, and thereby to amplify the storage capacity of a certain type (e.g., cold or hot).

The system may be operated in a charging mode, in a discharging mode, or in a simultaneous charging and discharging mode. In the simultaneous charging and discharging mode, the heat pump is operated to increase the storage of heat, at the same time as heat is discharged from the high and low temperature tanks to user loads, thereby increasing the overall power discharge.

The systems and methods described herein feature various benefits. First, the systems feature a high COP. Utilizing the systems and methods described herein, it is possible to generate a COP of above 6.0, or even above 7.0, representing a significant improvement over known systems such as heat pump systems. Second, the systems enable energy savings by optimizing time of use (TOU); namely, storing energy at less expensive times and tariffs and utilizing the energy at more expensive times and tariffs along the day. Third, the systems and methods described herein may be utilized to store energy over a period of long duration and in a flexible manner. When the system integrates closed and open loop storage, the system can be utilized to provide flexible storage solutions, even beyond the capacity of the high temperature and low temperature storage tanks.

Additionally, systems of the invention may be modular and scalable. The storage tanks may be of any size and dimension, consistent with the available space in the location in which they are installed. The power source for the system may itself be a green energy source, such as photovoltaic panels, or waste heat. The system may thus be implemented as part of a microgrid, in which all of the sources of energy are derived from renewable sources, without needing to be connected to a larger energy grid.

As further demonstrated herein, in some cases, the high and low temperature tanks may contain water which is directly utilized by the user, e.g., for provision of hot and cold water. In such cases, there is no need for heat exchange between the high or low temperature tanks and the hot or cold water, since they are the same.

According to a first implementation, a thermal energy generation system such as a heat pump is provided for dual storage of thermal energy. The system heat pump includes at least a pair of thermal storage tanks, wherein at least one of said pair of thermal storage tanks is a high temperature tank (interchangeable with “hot tank”) and at least one another of said pair of thermal storage tanks is a low temperature tank (interchangeable with “cold tank”). Each of the thermal storage tanks is configured to hold or contain therein a thermal storage substance having a predetermined heat capacity. The system further includes means for producing a temperature gradient between the tanks. Such means may be in a form of at least one refrigeration cycle that is configured and operable as a vapor compression cycle, or such means as a thermoelectric cycle, a magnetocaloric cycle, or a thermoacoustic cycle and others. The high temperature tank and the low temperature tank are each thermally coupled to the e.g., refrigeration cycle such that, during operation of a vapor compression cycle, heat is withdrawn from the thermal storage substance in the low temperature tank to the refrigeration cycle (i.e., to the refrigerant), and simultaneously heat is withdrawn from the at least one refrigeration cycle (i.e., from the refrigerant) to the thermal storage substance in the high temperature tank.

In a first of its aspects, there is provided a thermal power storage system for storage of thermal energy, the system comprising
at least a pair of thermal storage tanks, wherein at least one of said pair of thermal storage tanks is a high temperature tank and at least one another of said pair of thermal storage tanks is a low temperature tank, wherein each of the thermal storage tanks is configured for holding therein a thermal storage substance having a predetermined heat capacity; and
at least one means for generating a temperature gradient.

The at least one means for generating a temperature gradient may be any such means known in the art, including for example one or more of a refrigeration cycle, a thermoelectric cycle, a magnetocaloric cycle, or a thermoacoustic cycle. In some cases, the means are a refrigeration cycle, that may be configured and operable for operation of a vapor compression cycle, wherein the high temperature tank and the low temperature tank are each thermally coupled to the refrigeration cycle and configured such that during operation of the vapor compression cycle heat is withdrawn from the thermal storage substance in the low temperature tank to the refrigeration cycle, and simultaneously heat is withdrawn from the at least one refrigeration cycle to the thermal storage substance in the high temperature tank.

The invention further provides a thermal energy storage system for storage of thermal energy, the system comprising
at least a pair of thermal storage tanks, wherein at least one of said pair of thermal storage tanks is a high temperature tank and at least one another of said pair of thermal storage tanks is a low temperature tank, wherein each of the thermal storage tanks is configured for holding therein a thermal storage substance having a predetermined heat capacity; and
at least one refrigeration cycle configured and operable for operation of a vapor compression cycle, wherein the high temperature tank and the low temperature tank are each thermally coupled to the refrigeration cycle and configured such that during operation of the vapor compression cycle heat is withdrawn from the thermal storage substance in the low temperature tank to the refrigeration cycle, and simultaneously heat is withdrawn from the at least one refrigeration cycle to the thermal storage substance in the high temperature tank.

The thermal storage substance, also known as a thermal energy storage (TES) material, may be any material that is capable of absorbing, storing, and releasing heat when needed. Such a material may be a single material, such as water, or a combination or a composition of different materials, e.g., salt solutions. Typically, the TES substance is a fluid material (following being charged); however, in some cases solid and semisolid materials may be used. The TES substance may be presented in a variety of forms and may be selected based on the material properties. Amongst such materials are phase change materials (PCMs), molten salts, sensible heat materials, thermochemical materials and others.

In some cases, the TES substance is water.

In other cases, the TES substance is a PCM. The PCM may be selected from salt hydrates or may be selected amongst water-soluble organic materials. The selection of such substances or PCMs may depend, at least partially, on the properties of the material and the intended use of the substance or PCM (e.g., as a TES substance for use in a high energy storage tank, or as a TES suitable for use in a low temperature storage tank). The number of TES substances used in the system of the invention or in a system incorporating one or more such systems may depend on the number of high and low temperature tanks. In some embodiments, the high temperature tank(s) and the low temperature tank(s) may contain different substances or PCM materials, wherein each of the substances or PCMs is configured to store thermal energy in a latent manner at different temperature ranges. As a non-limiting example, a substance or a PCM for use in the high temperature tank may be selected based on its ability to store heat in a latent form at a temperature not exceeding or up to approximately between 54 and 59° C. A different substance or PCM for use in the low temperature tank may be selected to store thermal energy in a latent form at a temperature as low as or down to approximately between 2 to 7° C. In some cases, the two substances or PCMs are selected such that their ability to store thermal energy is reflected in a temperature difference of at least 20° C., or 30, or 40, or 50, or 60° C. or more.

The thermal energy storage system may further include an ambient heat exchanger; one or more valves may be used to thermally connect each of the thermal storage tanks to the ambient heat exchanger and to thermally disconnect each of the thermal storage tanks from the refrigeration cycle. The valves are controllable to switch the system from a closed loop system, in which both thermal storage tanks exchange heat directly via the refrigeration cycle, to an open loop system, in which at least one of the thermal storage tanks exchanges heat with ambient environment. Alternatively, the open loop configuration may be achieved through connection with the refrigeration cycle. In such embodiments, the system further includes an ambient heat exchanger and one or more valves configured to thermally connect the refrigeration cycle to the ambient heat exchanger, wherein the one or more valves are controllable to switch the heat pump from a closed loop system, in which the refrigeration exchanges heat only with the thermal storage tanks, and an open loop system, in which the refrigeration exchanges heat with ambient atmosphere.

Optionally, the thermal energy storage system may comprise more than two thermal storage tanks. For example, there may be three or more sets or pairs of thermal storage tanks, wherein each set of thermal storage tanks contains a thermal storage substance that is configured to store thermal energy at a different temperature. In such embodiments, each thermal storage tank may be configured with a distribution member for distribution of thermal energy to user loads having different temperatures.

The at least one refrigeration cycle may comprise two refrigeration cycles arranged in a cascade, whereby one refrigeration cycle is thermally coupled to the low temperature tank, a second refrigeration cycle is thermally coupled to the high temperature tank, and the two refrigeration cycles are thermally connected to each other via an intermediate temperature thermal storage tank functioning as a heat exchanger. The intermediate temperature storage tank thus receives heat from one refrigeration cycle and from a second refrigeration cycle, and thus is maintained at an intermediate temperature.

In some configurations, the at least one refrigeration cycle may comprise two refrigeration cycles arranged in a cascade, whereby one refrigeration cycle is thermally coupled to the low temperature tank, a second refrigeration cycle is thermally coupled to the high temperature tank, and the two refrigeration cycles are thermally connected to each other through a heat exchanger. In such embodiments, the heat exchanger may be a separate device and does not, in and of itself, serve as a thermal storage.

Optionally, the at least one pair of thermal storage tanks comprises three or more thermal storage tanks, and wherein each of the three or more thermal storage tanks is connected to a single refrigeration cycle. The system further includes a plurality of three-way valves. The three-way valves are controllable to select any two of the thermal storage tanks to exchange heat with the refrigeration during operation of the vapor compression cycle.

The thermal energy storage system may further include a heat balancing conduit for directly transferring thermal energy from the high temperature cycle, (tank) to the low temperature cycle (tank).

The thermal energy storage system may further include heat distribution members. These are configured to distribute stored thermal energy to user loads for heat and cooling. The heat distribution members may be, for example, insulated pipes. Optionally, the thermal storage substance in each thermal storage tank is water, and the insulated pipes are configured to deliver the hot or cold water directly to user loads. Advantageously, in such scenarios, there is no need to perform heat exchange between the water and another thermal storage material.

The heat exchange members may be configured to discharge stored thermal energy to the user loads independently of each other. Thus, the thermal energy discharge may proceed simultaneously from both thermal storage tanks, or may be performed by only one at a time. The heat exchange members may be configured to discharge stored thermal energy to the user loads both when the system is being operated to store thermal energy and when the system is not being operated to store thermal energy. The ability of the system to discharge thermal energy to user loads is independent of the ability of the system to continue to charge the thermal storage tanks.

The system may further include a renewable energy source for powering operation of the refrigeration cycle. This renewable energy source may be, for example, photovoltaic panels. Optionally, the system further includes a battery for storing electrical energy generated by the renewable energy source. In such configurations, the system may function as a microgrid, completely independent of grid power.

The refrigeration cycle may include a refrigerant, a compressor, evaporator, expander, and condenser arranged in sequence. In some configurations, the condenser is configured to exchange heat with the high temperature tank, and the evaporator is configured to absorb heat with the low temperature tank.

The invention also concerns a system implementing a thermal energy storage system. The system may comprise the thermal energy generation system, as described herein; a high temperature distribution members for distributing stored heat from the high temperature tank to a user load, and a low temperature distribution members for distributing stored heat from the low temperature tank to a user load; and a controller configured to monitor thermal energy resources, consumption by users, ambient temperature, and determine a rate and/or timing of conversion and/or supply of the thermal energy resources, so as to maximize energetic efficiency of the system. The controller may utilize AI and modeling technologies so as to maximize the energetic efficiency and economics of the heat pump.

According to a further aspect, a method for storing thermal energy is disclosed. The method comprises operating a vapor compression cycle on a thermal energy storage system unit as defined herein; wherein during operation of the vapor compression cycle, withdrawing heat from the low temperature tank to the refrigeration cycle and simultaneously from the refrigeration cycle to the high temperature tank; and storing the withdrawn heat as thermal energy in the respective thermal storage substances. The thermal energy may be stored in a sensible manner or a latent manner.

The thermal energy generation system used in a method of the invention may be a heat pump or any other option according to any one or more of the embodiments disclosed herein.

The thermal energy storage system used in a method of the invention may further comprise an ambient heat exchanger and one or more valves configured to thermally connect each of the thermal storage tanks to the ambient heat exchanger and to thermally disconnect each of the thermal storage tanks from the refrigeration cycle. In such embodiments, the method may further include operating the one or more valves to thereby connect at least one of the thermal storage tanks to the ambient heat exchanger, to thereby convert the system from a closed loop state to an open loop state; and operating the vapor compression cycle when the system is in the open loop state to thereby charge one tank while maintaining the other tank idle. In such embodiments, the method may further include operating the vapor compression cycle in reverse when the system is an open loop heat state to thereby generate flexible storage capacity in one of the temperature tanks while the other temperature tank remains idle. The flexible storage capacity is stored in a sensible manner. The method may further include discharging the thermal energy generated with flexible storage capacity to a user load and subsequently discharging the thermal energy generated at the other temperature tank to the same user load. The flexible storage capacity thus enables the thermal energy storage system to serve excess demand for one type of storage.

In some cases, the thermal energy storage system may further comprise an ambient heat exchanger and one or more valves configured to thermally connect the refrigeration cycle to the ambient heat exchanger, and the method further comprises operating the one or more valves to open a thermal connection between the refrigeration cycle and an ambient heat exchanger, to thereby convert the system from a closed loop to an open loop system; and operating the vapor compression cycle in an open loop system.

The method may further include discharging stored thermal energy from the low temperature tank to at least one cold user load and discharging stored thermal energy from the high temperature tank to at least one hot user load. The discharging of the thermal energy to the cold and hot user loads may be performed independently of each other. The discharging may be performed while the thermal energy generation system is operating to generate additional thermal storage.

The invention further concerns:

A thermal energy storage system for storing thermal energy, the system comprising
at least a pair of thermal storage tanks, wherein at least one of said pair of thermal storage tanks is a high temperature tank and at least one another of said pair of thermal storage tanks is a low temperature tank, wherein each of the thermal storage tanks is configured for holding therein a thermal storage substance having a predetermined heat capacity; and
at least one refrigeration cycle for operation of a vapor compression cycle, wherein the high temperature tank and the low temperature tank are each thermally coupled to the refrigeration cycle and configured such that during operation of the vapor compression cycle heat is withdrawn from the thermal storage substance in the low temperature tank to the refrigeration cycle, and simultaneously heat is withdrawn from the at least one refrigeration cycle to the thermal storage substance in the high temperature tank.

In some configurations of any of the thermal energy storage system of the invention, the thermal storage substance is water.

In some configurations of any of the thermal energy storage system of the invention, the thermal storage substance is a phase change material.

In some configurations of any of the heat pumps of the invention, the phase change material is a salt hydrate.

In some configurations of any of the heat pumps of the invention, the phase change material in the high temperature tank is configured to store latent heat at a temperature of up to approximately 54-59° C., and the phase change material in the low temperature tank is configured to store latent heat at a temperature down to approximately 2-7° C.

In some configurations of any of the thermal energy storage systems of the invention, the system further comprising an ambient heat exchanger, and one or more valves configured to thermally connect each of the thermal storage tanks to the ambient heat exchanger and to thermally disconnect each of the thermal storage tanks from the refrigeration cycle, wherein the one or more valves are controllable to switch the heat pump from a closed loop system, in which both thermal storage tanks exchange heat with only the refrigeration cycle, to an open loop system, in which at least one of the thermal storage tanks exchanges heat with ambient atmosphere.

In some configurations of any of the thermal energy storage systems of the invention, the system further comprising an ambient heat exchanger and one or more valves configured to thermally connect the refrigeration cycle to the ambient heat exchanger, wherein the one or more valves are controllable to switch the system from a closed loop system, in which a refrigerant exchanges heat only with the thermal storage tanks, and an open loop system, in which the refrigerant exchanges heat with ambient environment.

In some configurations of any of the thermal energy storage system of the invention, the at least a pair of thermal storage tanks comprises three or more sets of thermal storage tanks, wherein each set of thermal storage tanks contains a thermal storage substance that is configured to store thermal energy at a different temperature.

In some configurations of any of the heat pumps of the invention, the at least one refrigeration cycle comprises two refrigeration cycles arranged in a cascade, whereby one refrigeration cycle is thermally coupled to the low temperature tank, a second refrigeration cycle is thermally coupled to the high temperature tank, and the two refrigeration cycles are thermally connected to each other via an intermediate temperature thermal storage tank functioning as a heat exchanger.

In some configurations of any of the thermal energy storage system of the invention, the at least one refrigeration cycle comprises two refrigeration cycles arranged in a cascade, whereby one refrigeration cycle is thermally coupled to the low temperature tank, a second refrigeration cycle is thermally coupled to the high temperature tank, and the two refrigeration cycles are thermally connected to each other through a heat exchanger.

In some configurations of any of the thermal energy storage systems of the invention, the system further comprising a heat balancing conduit for directly transferring thermal energy from the high temperature cycle to the low temperature cycle.

In some configurations of any of the thermal energy storage systems of the invention, the system further comprising heat distribution members configured to distribute stored thermal energy to user loads for heating and cooling.

In some configurations of any of the thermal energy storage systems of the invention, the heat distribution members comprise insulated pipes.

In some configurations of any of the thermal energy storage systems of the invention, the thermal storage substance in each thermal tank is water, and the insulated pipes are configured to deliver the hot or cold water directly to user loads.

In some configurations of any of the thermal energy storage systems of the invention, the heat exchange members are configured to discharge stored thermal energy to the user loads independently of each other.

In some configurations of any of the thermal energy storage systems of the invention, the heat exchange members are configured to discharge stored thermal energy to the user loads both when the system is being operated to store thermal energy and when the system is not being operated to store thermal energy.

In some configurations of any of the thermal energy storage systems of the invention, the system further comprising a renewable energy source for powering operation of the refrigeration cycle.

In some configurations of any of the thermal energy storage systems of the invention, the system further comprising a battery for storing electrical energy generated by the renewable energy source.

In some configurations of any of the thermal energy storage systems of the invention, the refrigeration cycle comprises a compressor, evaporator, expander, and condenser arranged in sequence; wherein the condenser is configured to exchange heat with the high temperature tank, and the evaporator is configured to exchange heat with the low temperature tank.

A system is provided which comprises:
a thermal energy storage system according to any embodiment of the invention;
a high temperature distribution member for distributing stored heat from the high temperature tank to a user load, and a low temperature distribution member for distributing stored heat from the low temperature tank to a user load; and
a controller configured to monitor thermal energy resources, consumption by users, ambient temperature, and determine a rate and/or timing of conversion and/or supply of the thermal energy resources, so as to maximize energetic efficiency and economics of the system.

A method is also provided for storing thermal energy, the method comprising
operating a vapor compression cycle on a thermal energy storage system according to any embodiment of the invention;
during operation of the vapor compression cycle withdrawing heat from the thermal storage substance in the low temperature tank to the refrigeration cycle, and simultaneously withdrawing heat from the at least one refrigeration cycle to the thermal storage substance in the high temperature tank; and
storing the withdrawn heat as thermal energy in the respective thermal storage substances.

In some configurations of any of the methods of the invention, the storing step comprises storing the thermal energy in a sensible manner.

In some configurations of any of the methods of the invention, the storing step comprises storing the thermal energy in a latent heat manner.

In some configurations of any of the methods of the invention, the thermal storage substances comprise fluids.

In some configurations of any of the methods of the invention, the thermal storage substances comprise or consist phase change materials.

In some configurations of any of the methods of the invention, the thermal energy storage system further comprises an ambient heat exchanger and one or more valves configured to thermally connect each of the thermal storage tanks to the ambient heat exchanger and to thermally disconnect each of the thermal storage tanks from the refrigeration cycle, the method further comprising:
operating the one or more valves to thereby connect at least one of the thermal storage tanks to the ambient heat exchanger, to thereby convert the system from a closed loop state to an open loop state; and operating the vapor compression cycle when the system is in the open loop state to thereby charge one tank while maintaining the other tank idle.

In some configurations of any of the methods of the invention, the method further comprising operating the vapor compression cycle in reverse when the thermal energy storage system is an open loop heat state to thereby generate flexible storage capacity in one of the temperature tanks while the other temperature tank remains idle.

In some configurations of any of the methods of the invention, the flexible storage capacity is stored in a sensible manner.

In some configurations of any of the methods of the invention, the method further comprising discharging the thermal energy generated with flexible storage capacity to a user load and subsequently discharging the thermal energy generated at the other temperature tank to the same user load.

In some configurations of any of the methods of the invention, the thermal energy storage system further comprises an ambient heat exchanger and one or more valves configured to thermally connect the refrigeration cycle to the ambient heat exchanger, and the method further comprises: operating the one or more valves to open a thermal connection between the refrigeration cycle and an ambient heat exchanger, to thereby convert the system from a closed loop to an open loop system; and operating the vapor compression cycle in an open loop system.

In some configurations of any of the methods of the invention, the method further comprising discharging stored thermal energy from the low temperature tank to at least one cold user load and discharging stored thermal energy from the high temperature tank to at least one hot user load.

In some configurations of any of the methods of the invention, the discharging step comprises discharging thermal energy to both the cold and hot user loads independently of each other.

In some configurations of any of the methods of the invention, the method further comprising performing the discharging step while the heat pump is operating to generate additional thermal storage.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a system with high and low temperature tanks, according to embodiments of the present disclosure;

FIG. 2 is a schematic illustration of the heat pump of FIG. 1, illustrating additional optional components thereof;

FIG. 3 illustrates a system with an option to change the operation of the heat pump from closed loop to open loop through connection to an ambient heat exchanger from either of the thermal storage tanks;

FIGS. 4A and 4B illustrate a heat pump with an option to change the operation of the heat pump from closed loop to open loop operation through connection to an ambient heat exchanger from the refrigeration cycle;

FIG. 5 illustrates a series of steps in which a system of the invention may be used for flexible storage capacity;

FIG. 6 illustrates exemplary energetic efficiency data when a system is used for storage, for discharge, and for simultaneous storage and discharge;

FIG. 7 illustrates a cascaded system with two compressors and two tanks containing different phase change materials;

FIG. 8 illustrates a cascaded system with low temperature, intermediate temperature, and high temperature tanks, and two different compressors, according to embodiments of the present disclosure;

FIG. 9 is a graph illustrating power consumption, stored thermal energy and COP over time, obtained when using an heat pump as an example of the present disclosure;

FIG. 10 is a graph illustrating thermal battery charging power vs. time;

FIG. 11 is a graph illustrating thermal battery discharge temperature vs. time;

FIG. 12 is a graph illustrating thermal battery discharge power vs. time; and

FIG. 13 illustrates an exemplary installation of the system on an apartment building.

FIG. 14 provides a general depiction of an AI control architecture for a thermal microgrid according to some embodiments of the invention.

### DETAILED DESCRIPTION OF EMBODIMENTS

The present disclosure relates to the field of energy management, and more specifically, but not exclusively, to a heat pump with storage tanks for high and low temperature substances. Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

In each of the examples described herein, the heat pump generates heat and cold using a vapor compression cycle. In the vapor compression cycle, as is known to those of skill in the art, a refrigerant undergoes phase and temperature changes, while exchanging heat with surrounding components. The use of a vapor compression cycle has certain advantages, insofar as the heat pump may be operated in a closed loop cycle, or an open loop cycle with the ambient atmosphere, as will be discussed further herein. In theory, however, the heat pump may be operated with any type of mechanism which produces a temperature gradient, such as thermoelectric, magnetocaloric, thermoacoustic cycles, etc.

The refrigerant that is used in the vapor compression cycle is typically a heat transfer fluid that is capable of transitioning between a gas and liquid phase, and that can be used in a heat transfer process. Examples of refrigerants include a compound specified in ISO 817 (International Organization for Standardization), and that is given a refrigeration number (ASHRAE number) representing the type of refrigeration with letter “R”. The refrigeration may be a fluorocarbon or a non-fluorocarbon compound and may be specifically selected from chlorofluorocarbons (CFC), hydrochlorofluorocarbons (HCFC), and hydrofluorocarbons (HFC). The refrigeration may also be a gas, such as carbon dioxide.

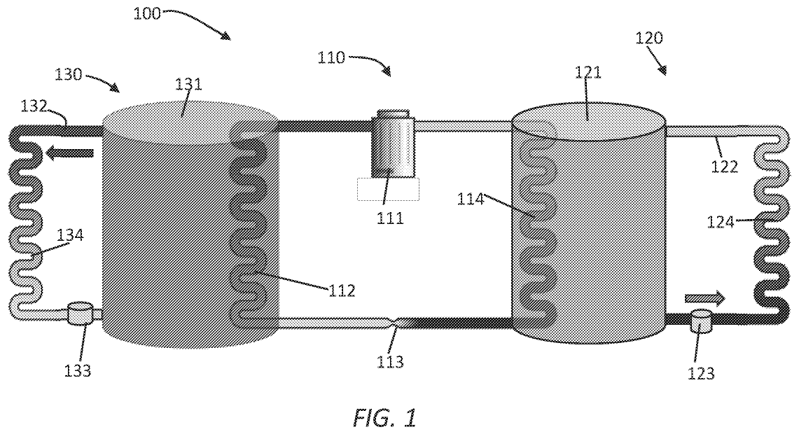

Referring now to FIG. 1, thermal energy generation system 100 is depicted schematically. Heat pump 100 is an integrated system that includes a vapor compression cycle 110 (in this implementation), a cold storage charge and discharge cycle 120, and a heat storage charge and discharge cycle 130. Heat pump 100 is configured to provide both cooling and heating simultaneously under any environmental condition.

The vapor compression cycle 110 includes the four basic components of any heat pump, arranged in sequence (counterclockwise in the view of FIG. 1): a compressor 111; a condensing coil 112; an expander or expansion valve 113, and an evaporator coil 114. The refrigeration undergoes temperature and phase transitions as it moves between different components of the heat pump. At compressor 111, a refrigeration at low temperature and low pressure is raised to a pressure that is sufficiently high to match a desired condensing temperature in the condenser. During the compression process, both the temperature and pressure of the refrigeration increase. As the compressor compresses the vapor to a higher pressure, its temperature rises and the refrigeration is pushed in a direction of the condensing coil 112, which removes heat from the hot gas and releases it to the high temperature tank 131 acting as a heat sink. Condensing coil 112 is a high-temperature heat exchanger, in which the refrigeration enters as a high-temperature vapor, rejects heat to the high temperature tank 131 by condensation at a high pressure and leaves as a high-temperature liquid. At the expander 113, the high-temperature, high pressure liquid refrigerant is allowed to expand. The expander may be a capillary tube or a thermal or electric expansion valve, or an electronic expansion valve, and may comprise one, two or more one-way expansion valves arranged in a switchable circuit, to cause expansion of the refrigerant. An alternative expansion device may comprise an arrangement of two asymmetric expansive devices connected with two one-way valves. As the pressure drops, the refrigerant starts to evaporate in the valve and the heat of evaporation is taken from the refrigerant, which causes its temperature to drop and the result is a low-temperature, low-pressure mix of liquid and vapor. The evaporator coil 114 is a low-temperature heat exchanger where the refrigerant enters as a low-temperature liquid, absorbs heat from the evaporation at a low pressure, thereby cooling the surrounding tank 121, and leaves as a low-temperature vapor.

In a conventional heat pump, such as an air conditioner, the evaporator coil is configured within an environment that is to be cooled, such as an apartment, and the condensing coil is within an environment that receives excess heat from the environment, such as ambient atmosphere. Such conventional heat pumps operate only as “open loop” systems, in which the ambient atmosphere is an unlimited resource for providing heat, and no thermal energy is stored.

The heat pump of the present disclosure differs from such conventional heat pumps in that it includes two thermal storage tanks: low temperature tank 121 and high temperature tank 131. The term “tank” is used in its broadest sense and refers to any structure suitable for containing therein a material that stores thermal energy (also referred to herein as TES substance). Each of these tanks is thermally coupled with the refrigeration cycle, and thus receives thermal energy during operation of the vapor compression cycle. The condensing coil 112 rejects heat to the high temperature tank 131, and the evaporator coil 114 cools the low temperature tank 121.

Tanks 121, 131 may be insulated to prevent equalization with the surrounding environment.

The tanks are discharged by the user to provide energy (high or low temperatures) to a user load (e.g., air conditioning or water heating). This discharge may be performed independently of the thermal storage, both during the vapor compression cycle and while the vapor compression cycle is not operational.

The tanks may be filled with any material capable of serving as an energy storage substance TES. In some embodiments, the tanks are filled with phase change materials (PCMs). The term “phase change material” refers to a substance which releases or absorbs energy at its phase transition point (e.g., from solid to liquid or vice versa) sufficiently to provide useful heating or cooling. A phase change material is, at the melting or freezing temperature thereof, a “latent” heat storage material, insofar as it stores heat (high or low temperatures) during a constant-temperature thermodynamic process. This is opposed to a “sensible” heat storage material, which rises or falls in temperature as heat is exchanged. The phase change material for each tank may be selected according to the material's phase change temperature and the desired temperature or temperature range at which the tank is intended to be maintained.

Salt hydrates are known examples of suitable phase change materials for thermal energy storage. In particular, the following salt hydrates, among others, have been studied and found suitable for thermal energy storage applications: CaCl₂·6H₂O (calcium chloride hexahydrate), Na₂S₂O₃·5H₂O (sodium sulfide pentahydrate), Na₂SO₄·10H₂O (sodium sulfate decahydrate, or Glauber's salt), Na₂CO₃·10H₂O (sodium carbonate decahydrate), Na₂HPO₄·12H₂O (sodium hydrogen phosphate dodecahydrate), MgSO₄·7H₂O (magnesium sulfate heptahydrate), MgCl₂·6H₂O (magnesium chloride hexahydrate), sodium acetate trihydrate (SAT). In some cases, the salt hydrate is SAT. When the heat storage material is a PCM, additional heat exchangers (not shown) may be utilized in order to deliver heat between the PCM and a user load.

In some embodiments, a phase change material is selected to store heat in a latent manner at a temperature of about between 54 and 59° C., and a different phase change material is selected to store heat at a temperature of between 2 and 7° C. Additional thermophysical properties of the phase change materials are described below, in connection with FIGS. 10-13 and Table 1.

There are various advantages of using phase change materials for thermal storage. Phase change materials are safe, sustainable, and recyclable. Furthermore, PCMs have a long lifetime of 10,000 cycles and more. Phase change materials, such as SAT, are also high-density with latent heat of fusion as high as 276 kJ/kg, and high density of over 1300 kg/m³, reflecting four times more space efficient than water. In some instances, the phase change materials have an energy density of 102 Watt hours (Wh) per kg, and a space density of 100 Wh/L. As a result, it is easier to fit the storage tanks within, or on top of, residential and commercial buildings. Moreover, the energy that is stored is delivered in a consistent manner. Unlike boilers, which can stratify into hot and cold layers due to density differences, PCMs absorb and release heat at a specific phase change point, allowing them to maintain a consistent temperature. This property, referred to herein as a “thermal cutoff effect,” allows the PCM to absorb any changes in temperature and invest the energy in phase changing rather than raising the temperature. When both storage tanks are filled with a PCM, a “dual thermal cutoff” mechanism is achieved. In other words, in one tank the higher temperature is suppressed from increasing, and in the other tank, the temperature is prevented from decreasing. This significantly improves the COP. In sum, the PCM reduces energy losses and improves the COP by maintaining constant temperature during heating or cooling.

The structures incorporating the PCMs may take any physical shape. In some embodiments, the PCM is encapsulated in thermal bricks and immersed in a water tank or tanks. In other embodiments, the PCM is not encapsulated but instead fills the whole storage tank.

Instead of a PCM, the tanks may be filled with water. Water stores heat in a sensible manner at temperatures close to ambient temperature. Advantageously, the water itself, being a fluid, is readily delivered from the high temperature tank or low temperature tank to a user load. For example, in the illustrated embodiment, the cold cycle 120 includes a temperature sensor 122, a pump 123, and a thermal exchange coil 124, for providing the low temperatures for the consumer uses (e.g., cooling a room). Similarly, the hot cycle 130 may include a temperature sensor 132, a pump 133, and a thermal exchange coil 134, for providing heat for the consumer uses (e.g., heating water).

The tanks may also be filled with fluids other than water. For example, the tanks may be filled with an organic solvent having a suitable heat capacity. In addition, the tanks may utilize other types of thermal energy storage, such as thermochemical.

In the illustrated embodiments, the high temperature and low temperature storage tanks are each depicted as a monolithic unit. In alternative embodiments, the high temperature and low temperature storage tanks are divided into cells, with each of the cells functioning as a separate thermal battery. This modular approach allows for scalability, with the ability to add or remove units as needed.

The difference in temperature between the low temperature tank and the high temperature tank, and the deviation of each from the ambient temperature, may be set according to the needs and desires of the system. This difference may be as low as even 5° C. or as high as 60° C., or even higher.

The volume of liquid or phase change material in each of the storage tanks typically remains constant, without a need for replenishment.

The system 100 of FIG. 1 is illustrated as a “closed loop” system. In this system, there is no heat exchange with the external environment during the vapor compression cycle. Accordingly, the heat exchange is solely between the high and low temperature thermal storage materials. This system is highly efficient, as, intrinsically, no heat may be wasted. However, it has limited practical uses, insofar as heat may be banked only when stored in the low temperature tank, and vice versa, and it is not possible to store one without the other.

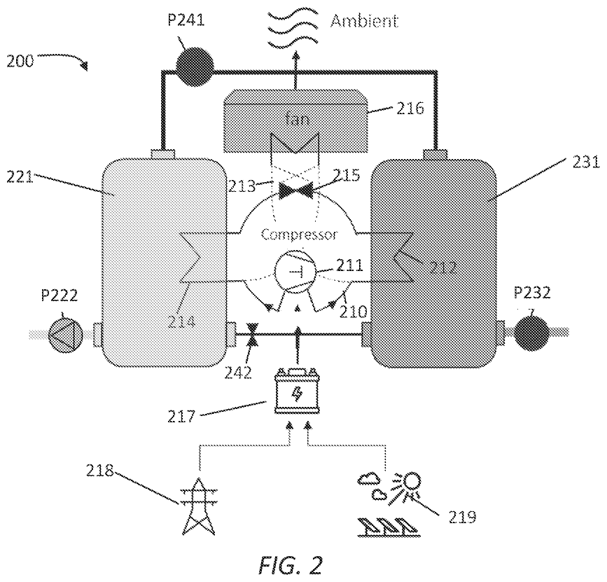

FIG. 2 illustrates another embodiment of the present system, in which the heat pump is configured to be toggled between a closed loop configuration and an open loop configuration. Vapor compression cycle 210 is illustrated as proceeding in a clockwise direction. Refrigerant proceeds between the compressor 211, to the condenser 212 within the high temperature tank 231, to the expansion coil 213, to the evaporator 214 within the low temperature tank 221. Some additional elements are also present. For example, a power source 217, for operation of the compressor 211, is schematically illustrated. This power source may be, for example, grid power 218, or renewable solar energy 219. In addition, in this embodiment, an ambient heat exchanger 216 is configured inline with the vapor compression cycle 210. One or more valves 215 (for purposes of the schematic image, only one is represented) are used to toggle the heat pump between a closed loop system, in which the refrigeration exchanges heat only with the low temperature tank 221 and high temperature tank 231, and an open loop system, in which the refrigerant exchanges heat with the ambient environment. The advantageous uses of heat exchange with the surrounding environment will be discussed further herein.

Also, in this embodiment, in addition to the pumps P222 leading to low energy loads, and pump P232 directed to hot energy loads, there is a pump P251 directed to equalization between the hot tank 231 and the low temperature tank 221. This equalization may be desirable, for example, if it is desired to warm the low temperature tank 221 beyond its current temperature, prior to delivering the low temperatures to the user load, such as in defrosting applications, or if it is desired to thermally balance the system i.e., to equalize the temperature of the two tanks so it can restart the charging process. Similarly, valve 242 may be opened or closed, as desired, in order to provide pressure equalization between low temperature tank 221 to the hot tank 231, as desired.

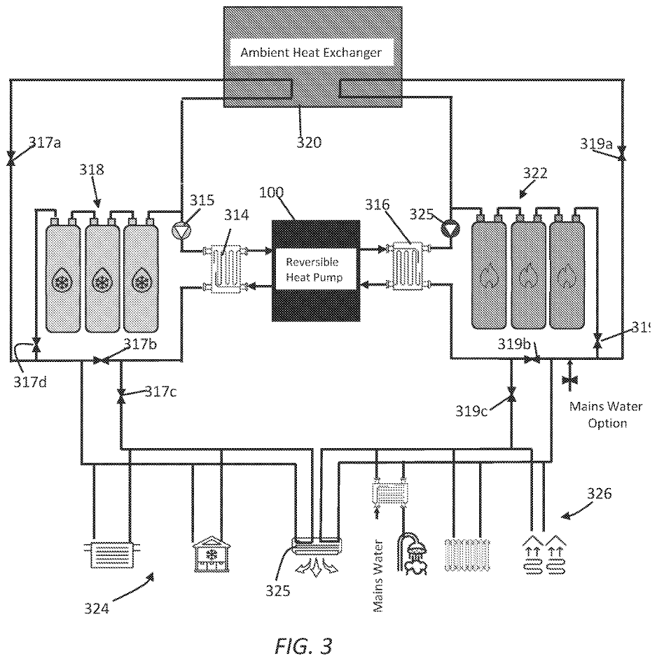

FIG. 3 illustrates a variation of a heat pump system 300 with additional elements. The heat pump system 300 includes, at its center, heat pump 100. Heat pump 100 operates with a vapor compression cycle having a refrigerant, as previously described. The evaporator for the vapor compression cycle is included within heat exchanger 314, and the condenser is included within heat exchanger 316.

Heat exchangers 314, 316 also include, on their outer ends, piping containing a fluid, such as water. This fluid is pumped to different components of the system in order to enable heat storage and discharge. Heat pump 300 may be operated either in a closed loop or open loop system. Various valves are implemented within the heat pump system in order to enable different functionalities of the heat pump system. To perform thermal energy storage in a closed loop, valves 317d and 317b are opened on the low temperature storage side, and valves 319d and 319b are opened on the heat storage side, with the other valves being closed. As a result, the fluid flows to low temperature tanks 318 and high temperature tanks 322. In the illustrated embodiments, there are three low temperature tanks 318 arranged in sequence. The three low temperature tanks may be the same temperature (i.e., they may be filled with phase changing material having a melting point in the same temperature range) or different temperatures (i.e., they are filled with phase changing materials having a melting point in different temperature ranges). The three low temperature storage tanks may also operate in parallel instead of in sequence (i.e., additional valves may be present that allow the refrigeration or fluid to flow through only one of the low temperature storage tanks 318 while bypassing the others). The same options are available for the high temperature storage tanks 322. In the closed loop configuration, thermal energy is stored in both tanks simultaneously.

System 300 may also be operated in an open loop configuration. In the open loop configuration, heat from only one storge tank is stored, while heat is exchanged with an ambient atmosphere through ambient heat exchanger 320. For example, when valves 319a and 391b are opened, and valves 319c and 319d are closed, the refrigerant on the hot side exchanges heat with the ambient atmosphere, via ambient heat exchanger 320. The refrigerant on the low temperature side may be opened to the low temperature storage tank 318 and closed to the ambient heat exchanger 320. In such a configuration, heat is stored at low temperature tank 318, but heat is not stored in high temperature tank 322. In the opposite configuration, the valves may be arranged such that heat is stored in high temperature tank 322 while, on the low temperature side, the heat is exchanged with the ambient atmosphere via ambient heat exchanger 320. Operating in an open loop configuration may be desired when, for example, the ambient environment is very hot or very cold, such that it is energetically favorable to utilize the ambient atmosphere as a source of heat, instead of the closed-loop option. Operating in the open loop configuration may also be useful in order to use the system for “flexible storage capacity,” as will be described further herein.

The system may be transitioned from closed to open loop in a smooth manner, simply by operation of valves to direct the flow of water or a refrigerant to an ambient heat exchanger. This transition may be performed without causing any fluctuations in pressure. In addition, the ability to transition to open loop configuration enables continuous delivery of power on one side (e.g., hot) while maintaining the other side (e.g., cold), fully charged.

System 300 also includes components for discharge of heat. On the heat side, the discharge may be to user loads 326, which include, for example, radiators, underfloor heating, or hot water. These user loads are served with two thermally insulated pipes (only one is schematically shown), one for input of the hot water and one for return flow of cooled water after heat exchange. On the low temperature side, the discharge may be to user loads 324, which include, for example, room coolers or industrial refrigerants. These user loads are also served with two pipes. The user load may also be a room climate control device 325, which may be used both for heating and cooling, and thus is fed with four insulated pipes-hot inlet, hot return, cold inlet, and cold return. The discharge components are accessed within system 300 by opening valves 317c or 319c, respectively.

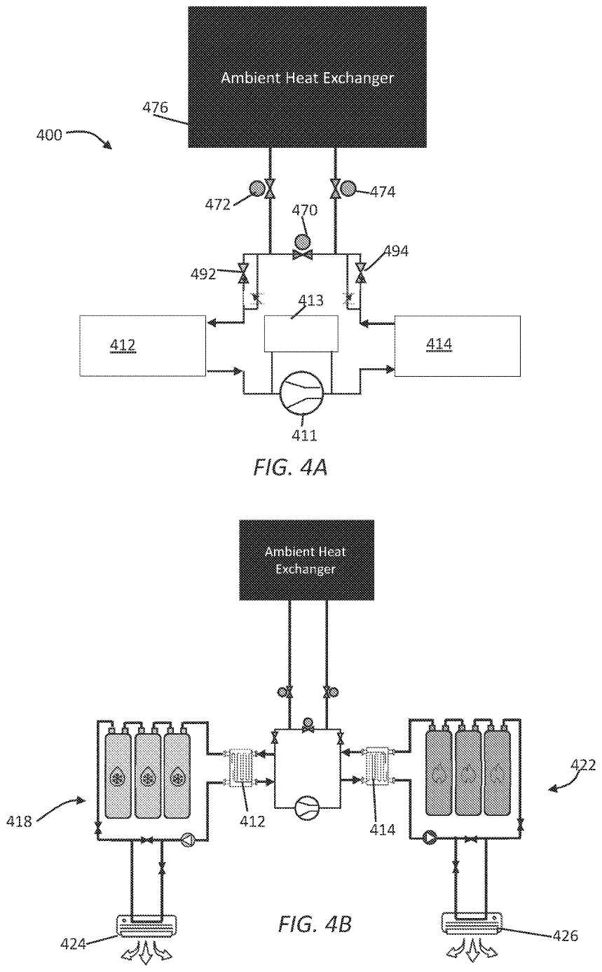

FIG. 4 illustrates how a system such as that of FIG. 3 may be used for “flexible storage capacity.” The term “flexible storage capacity” refers to the use of a low temperature heat storage tank, or a storage tank for higher temperatures. This is accomplished by running the heat pump as an “open loop” system, while alternately storing heat on both sides of the heat pump. As a result, the capacity of the heat pump for storage of heat may increase significantly according to the equation:

$$Flexible Capacity Ratio ( PCR ) = \frac{X * Qlatent + Y * Qsensible}{X * Qlatent} ,$$

wherein X represents number of hot modules and Y number of cold modules, and Qₗₐₜₑₙₜ represent heat of fusion in kJ/kg which is a property of the matter and is constant, and Q_{sensible} the sensible heat of the PCM which is described by Q_{sensible}=m*Cp*(T_{high}−T_{low}). In the private case where X=Y it is described by

$$Flexible Capacity Ratio ( FCR ) = 1 + \frac{Qsensible}{Qlatent} .$$

If T_{high} is equal to the temperature of fusion of the PCM, the ratio is 20% capacity boosting or augmentation.

Only part of the modules can be subjected to the flexible storage capacity or all of the modules. If only part of modules is changed, essentially it enables constant dynamically adjusting hot and cold storage proportions, so that it will match seasonality and even each day's unique characteristics in terms of consumption and weather. This ability is unique and provides high utilization of the dual thermal battery throughout the year. This can be done using an AI-based controller and forecast which can determine the optimized proportions for each day of the year.

In addition to the flexibility available through the storage of additional heat, the flexible storage capacity has other benefits. These include increased storage on one side to prepare for extreme weather events where more energy is needed, or blackouts and planned outages, and thus increase energy resilience and independence.

FIGS. 4A and 4B present an alternative embodiment of a heat pump system 400. In this embodiment, where there is no use of hot or chilled water, only a refrigeration, the refrigeration itself is capable of being alternated between a closed loop mode and an open loop mode. System 400 includes a compressor 411, which is connected in a cycle to a 4-way valve 413. The 4-way valve is used to change the direction of operation of the heat pump, as desired. If the system is imagined as proceeding in a clockwise fashion, the system further includes heat exchanger 414 for cold, thermal expansion valve 492 with a non-return valve for disabling flow in the opposite direction; a thermal expansion valve 494, which operates with a non-return valve for disabling flow in the opposite direction, and a heat exchanger 412 for heat. The system also includes an ambient heat exchanger 476, a bypass valve for bypassing the heat exchanger 476, and two additional valves 472, 474, for permitting the refrigerant to access the ambient heat exchanger 476.

FIG. 4B illustrates the system of FIG. 4A, a variation where the bypass valve is on the refrigeration cycle, but hot and cold water are used to store thermal energy and to deliver it to the consumer, with the additional components of the system, including thermal storage tanks 418, 422 and user loads 424, 426.

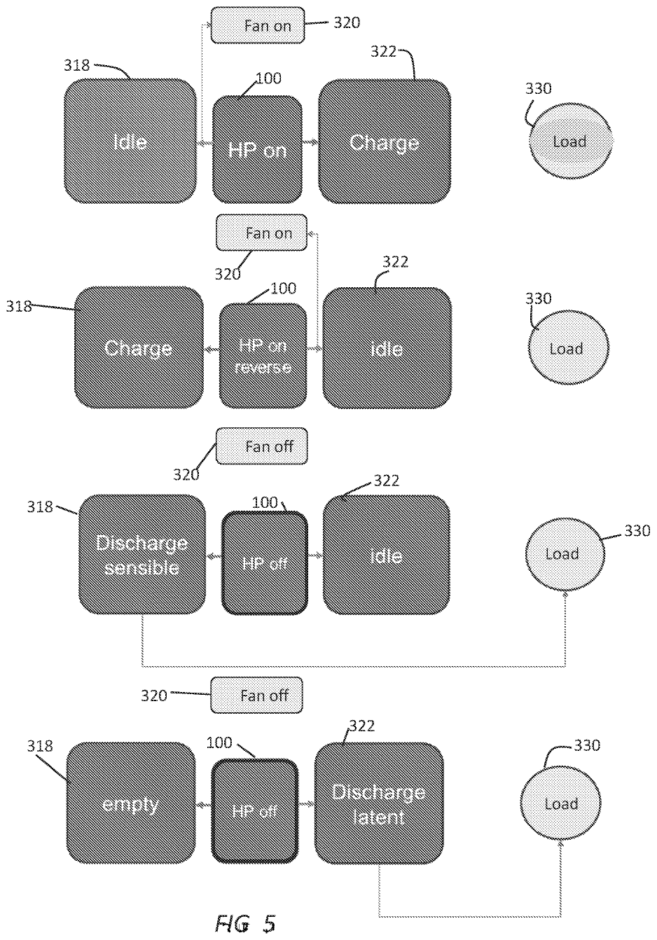

Referring now to FIG. 5, when the system is operated in an open loop configuration, it is possible to charge both storage tanks with the same type of thermal energy, in order to obtain “flexible storage capacity.” The manner in which this may be done is illustrated in FIG. 5. In the first step illustrated at the top of FIG. 5, the heat pump 100 is operated in an open loop cycle between the high temperature tank 322 and the ambient heat exchanger 320. During this process, heat is stored in the high temperature tank 322. When the high temperature tank 322 includes a phase change material, this heat storage occurs in a “latent” manner. During this time, the high temperature tank 318 is bypassed (Fan on), and thus is idle, while the cold energy is emitted to the environment. At the next stage, and continuing lower in FIG. 5, the heat storage tank 322 is idle. Heat pump 100 is run on reverse, thereby rejecting low temperatures to the environment, but this time from the other side, via ambient heat exchanger 320. The cold storage tank 318 stores heat. This heat storage is sensible, rather than latent, because the heat storage occurs above the melting temperature of the so-called cold PCM, and thus the PCM is not configured to store heat in a latent manner. Thus, it is less efficient than latent storage. Still, the storage of heat may be advantageous, if additional heat storage is desired. At the third stage, the heat pump may be turned off. The stored heat is discharged from the low temperature tank 318. The thermal exchange with the ambient heat exchanger 320 is closed, and the heat exchange to the load 330 is opened. As a result, the user load is heated, and the low temperature tank 318 is returned to its initial state, in which it may be used to store heat. At the fourth stage, the heat pump is still off. Latent heat is discharged from heat storage tank 322 and is delivered to load 330. The discharge process of the two last steps may be done in the opposite order. The charging process described in the first two steps may also done in the opposite order where the system will store cold energy on both sides, rather than heat.

As may be readily recognized by one of skill in the art, a parallel list of steps may be performed in order to achieve flexible storage capacity of low thermal energy, utilizing the high temperatures storage tank 322 to obtain sensible storage and discharge of low thermal energy.

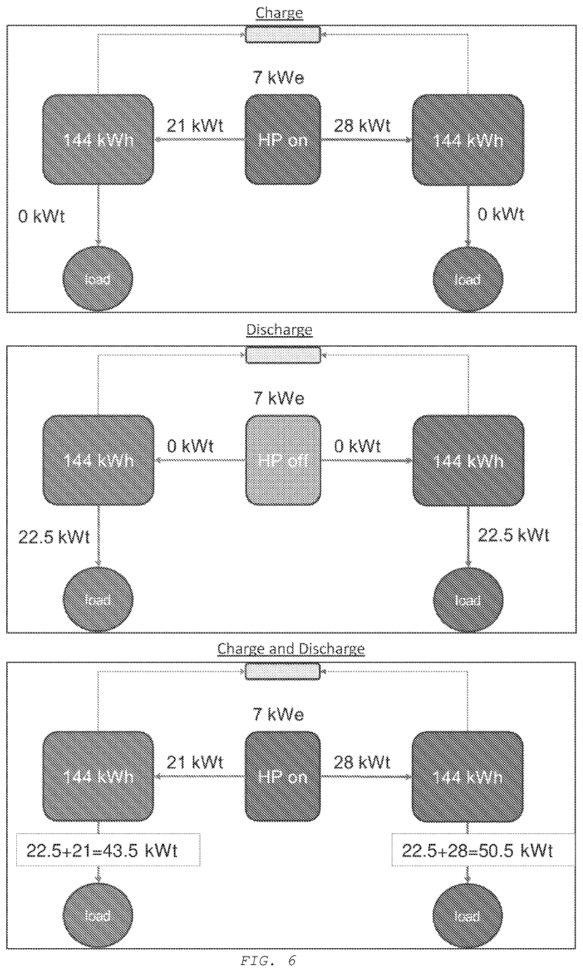

FIG. 6 illustrates how the system described herein may be utilized for storage, discharge, or both simultaneously for increased power. FIG. 6 illustrates exemplary energetic benefits that may be achieved through using the system for storage and discharge. At the top of FIG. 6, the heat pump is operated at a power of 7 kWe (kilowatt-electric) and a COPh=4 and a COPc=3. The heat storage increases by 28 kWₜh/hat the high temperature tank, and 21 kWₜh/hat the low temperature tank. The difference in heat storage is derived from the different storage capacities of the materials that are used for the heat storage. In total, the COP (Coefficient of Performance) of the system is 7.0-49 kWₜh/h of energy are charged with an investment of 7.0 kilowatts of electrical energy. In the illustrated embodiment, both the heat and low temperature tanks have a storage capacity of 144 kilowatt-hours (kWh), and they are both stored to their maximum capacities. In the middle scheme of FIG. 6, the hot and low temperature tanks are discharged, where the discharge power can be determined using the flow of water through the storage modules, but is assumed here to be constant and low for simplicity sakes. The heat pump is off. A discharge of 2.5 kWt from both the heat and low temperature tank is achieved using very low power requirements of a water pumps or by using the main water grid pressure.

In the lowest scheme of FIG. 6, the heat pump is on, thereby generating heat and the hot and low temperature tanks are also being discharged. This scheme illustrates the maximum energy that could be released from the system at any given time. The energy provided to each load is the sum of the energy obtained from each of the previous two schemes (e.g., 43.5 kWₜh/h on the cold side and 50.5 kWₜh/h on the hot side).

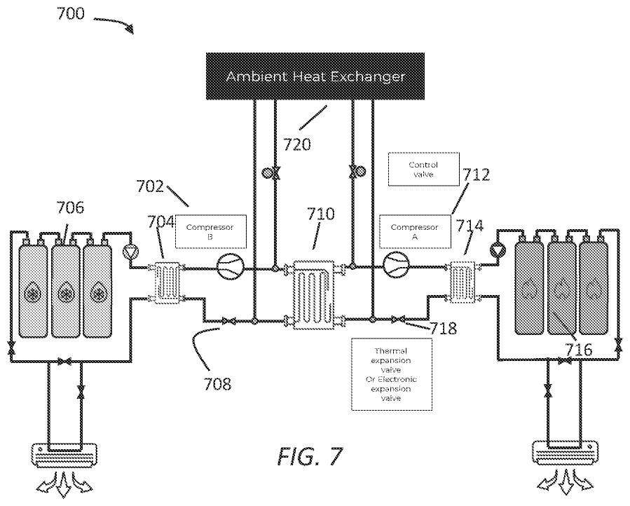

Referring now to FIG. 7, another configuration which leads to energetic benefits is illustrated. In this configuration, multiple heat exchangers are cascaded. In the embodiment of FIG. 7, there are two heat exchange cycles—a cold heat exchange cycle at the left side of the Figure, and a hot heat exchange cycle at the right side of the Figure. The cold cycle includes compressor 702, a heat exchanger 704 for connecting to the low temperature tank 706, and a thermal expansion valve 708. The hot cycle includes a compressor 712, a heat exchanger 714 for connecting to the high temperature tank 716, and a thermal expansion valve 708. The two cycles are joined by a heat exchanger 710 (for closed loop operation) and an ambient heat exchanger 720 (for open loop operation). This configuration may be used in the cold cycle from −5° C. to 30° C. and 25° C. to 60° C. on the hot cycle, therefore achieving high temperature lift of 65 degrees, but with a high COP than may even exceed 8, due to the cascade which acts as a heat pump on top of another heat pump.

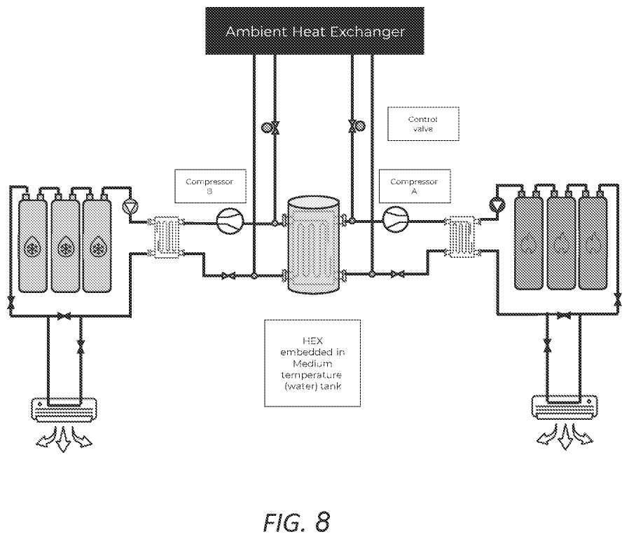

As may readily be understood by those of skill in the art, the variations of FIGS. 7, and 8 may include more levels of cascade to further increase the temperature swing without compromising for COP. Also, FIGS. 7 and 8 may be combined with one another. That is, the cascade may include ambient heat exchangers in combination with the configurations of FIG. 8. Moreover, the cascade may include some storage tanks served by multiple compressors, and other storage tanks served by a single compressor with three-way valves.

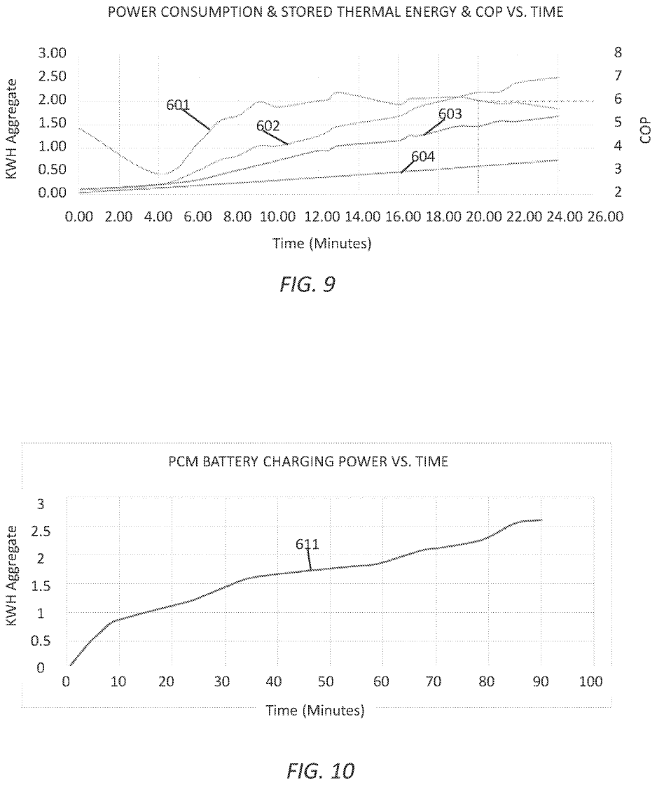

FIGS. 9-12 illustrate data regarding energy storage and discharge using systems according to some non-limiting embodiments of the present disclosure.

FIG. 9 contains graphs illustrating the energetic characteristics of the system during charging of the tanks. Graph 601 is a measure of COP over time; the scale of the Y-axis of graph 601 is on the right side of the graph. As can be seen, COP reaches a maximum of over 6.0, and, after approximately 10 minutes, is essentially constant. Graph 602 is a measure of high temperature thermal energy stored or aggregated, graph 603 is a measure of low temperature thermal energy stored or aggregated, and graph 604 is a measure of aggregated power consumption by the heat pump. Each of these graphs is measured with the Y-axis on the left, with units of aggregate kilowatt-hours. As can be seen, these measures are essentially constantly rising over time, with the heat storage proceeding faster than the cold storage, due to the different energetic properties of the PCMs in the respective heat and low temperature tanks.

The COP of 6.0, or even higher in other circumstances, is achieved under ideal conditions. In particular, the COP is the highest when the difference in temperature between the cold and hot tanks is beneath a certain limit and beneath a certain deviation from the ambient temperature. The COP typically drops at temperatures farther from the ambient due to heat loss to the environment; this may be prevented with proper insulation. In the example of FIG. 9, the ambient temperature was 35° C., the hot tanks were charged to 60° C. (2.2 KWht), and the low temperature tanks were charged to 19° C. (1.5 KWht).

FIG. 10 illustrates the charged energy of the system over time. The PCM charging energy 611 is charted in a measure of aggregate kilowatt hours over time. As can be seen, the system gradually and essentially steadily increases its overall energy storage over a period of 90 minutes, where the inclination of the graph is slightly reduced between minute 30 and 60, where the PCM changed its phase—as expected from the theory.

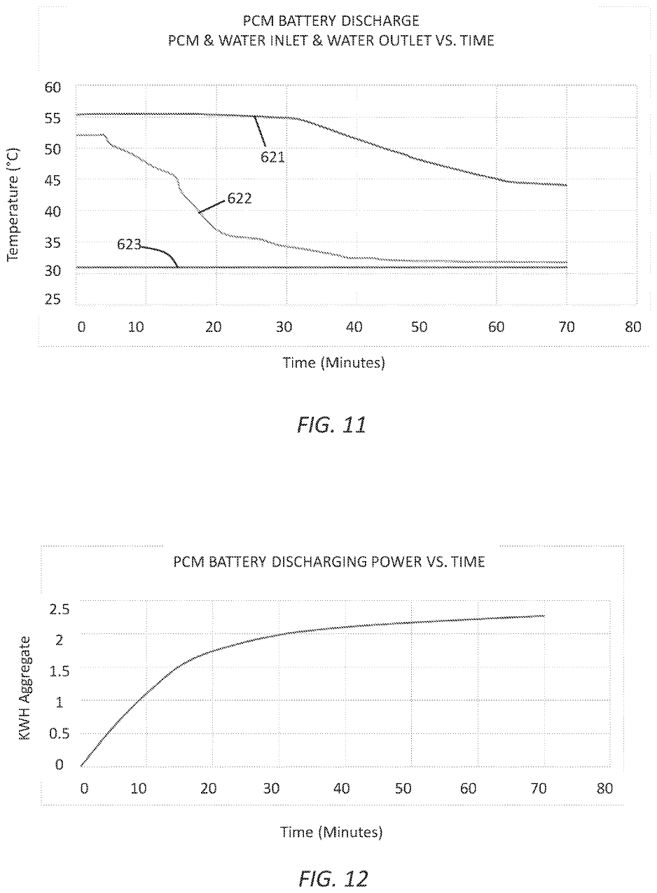

FIG. 11 illustrates a temperature graph as the high temperature tank is discharged to a user load (e.g., used to heat water). The temperature of the cold water inlet of the user load is indicated with graph 623. As expected, this temperature remains constant the entire time. The temperature of the PCM serving as a high temperature thermal storage is indicated in graph 621. For approximately the first 15 minutes, the high temperature thermal storage discharges heat in a latent manner. After that, when the PCM has completely solidified, the PCM continues to discharge heat in a sensible manner. The temperature of the water that is heated is indicated in graph 622. The heated water reaches its highest temperature at the beginning of the discharge process.

FIG. 12 illustrates the aggregate power that is discharged by the PCM battery over time. As can be seen, the discharged power steadily increases until the battery is completely discharged. As is evident from a comparison of FIG. 10 and FIG. 12, the charging process is more efficient than the discharging process. There is a relatively linear increase in thermal energy in FIG. 10 as compared to FIG. 12. The reason for this is because, at liquefaction, the PCM closer to the heat transfer area is liquid, with a better heat transfer efficiency than the equivalent solid PCM.

Table 1 illustrates thermophysical properties for one example of a heat pump system involving PCMs for heat storage and cold storage, for a heat pump in which the hot storage is at 58° C. and the cold storage is at 5° C.

TABLE 1
Thermophysical Properties

| | PCM for Heating | | PCM for cooling | |
|---|---|---|---|---|
| Melting temperature range | 56-59 | [° C.] | 2-7 | [° C.] |
| Congealing temperature range | 56-54 | [° C.] | 5-2 | [° C.] |
| Heat storage capacity ± 7.5% | 250 | [kJ/kg] | 155 | [kJ/kg] |
| Specific heat capacity | 2 | [kJ/kg · K]* | 2 | [kJ/kg · K]* |
| Density solid at 20° C. | 1.3 | [kg/l] | ~1.4 | [kg/l] |
| Density liquid at 65° C. | 1.2 | [kg/l] | ~1.3 | [kg/l] |
| Volume expansion | ~8 | [%] | ~7 | [%] |
| Heat conductivity | 0.6 | [W/(m · K)] | ~0.6 | [W/(m · K)] |

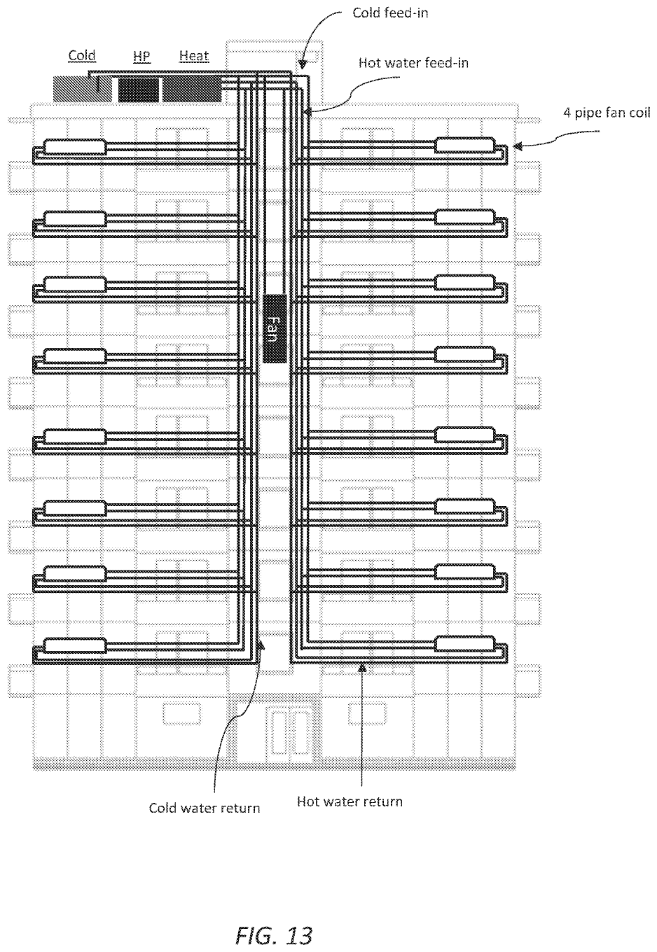

Referring to FIG. 13, the thermal storage infrastructure described herein may be implemented at various locations in and around a building. In particular, due to the relatively compact size of the heat and low temperature tanks, they may be placed in various locations. These include the basement of the building, the roof of the building, and on ground at the side of the building. In addition, the modular nature of the tanks allows them to be stacked one on top of the other, as desired.

In the illustration of FIG. 13, the heat pump is configured on the roof of the building. The refrigeration cycle, the high temperature storage units, and the low temperature storage units are all on the roof. The ambient heat exchanger, in this configuration, is mounted on the side of the building on the ground or higher. Each of the units of the building is connected to both the high temperature and low temperature storage tank with two pipes, namely an inlet pipe and a return pipe.

The infrastructure described herein may also be connected with solar panels that are mounted on the roof of the building, to thereby enable the system to function in an even more energy-efficient manner. The solar panels also allow the system to be charged with cheaper energy than the grid, or even when grid power is unavailable, e.g. during a blackout.

As discussed previously, the system described herein is fully scalable. The number of heat and low temperature tanks and the size thereof may be scaled according to the size of the building or buildings that are served therewith.

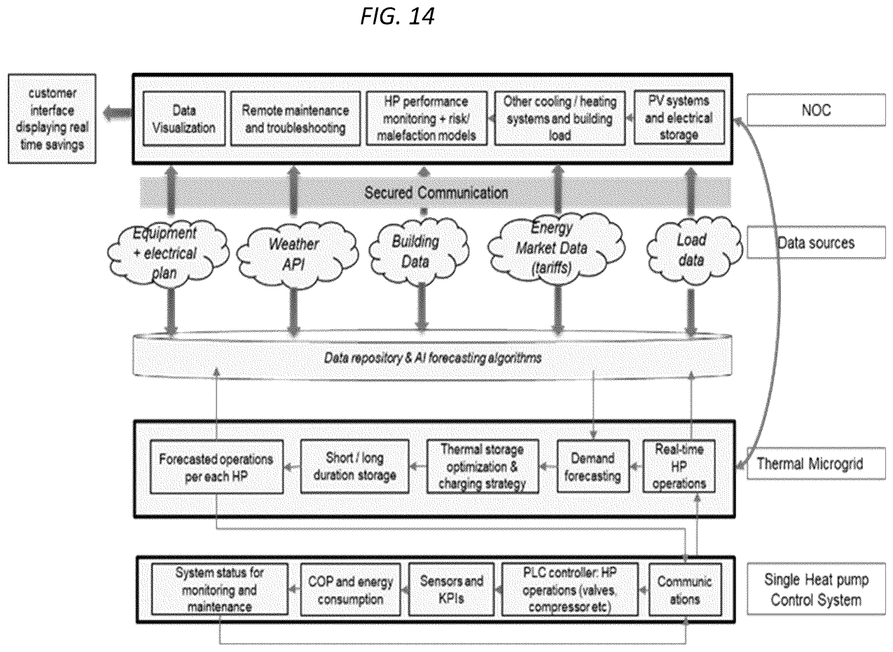

A control system may be utilized to implement the storage systems and methods described herein. A general depiction of an AI control architecture for a thermal microgrid is provided in FIG. 14. The control system may utilize AI and digital twin simulation technologies to learn consumption patterns and correlate them with solar radiation, tariffs, and historical datasets, in order to forecast the optimal charging and discharging strategy. The control strategy also addresses, inter alia, whether to charge the system in closed loop or open loop, and whether to charge in standard capacity or flexible capacity, whether to discharge stored heat simultaneous with the vapor compression cycle or independently thereof, etc. The control system may also be used in order to determine whether it is more favorable to use solar power or grid power in order to operate the system. As a result of all these control decisions, the system efficiently charges both tanks at low power and minimal tariffs, while ensuring that thermal energy for hot water or air conditioning is always available when needed.

In specific applications, the control system is configured to operate the heat pump and any other unit to improve control of the changes in the system's capacities and time of operation. For example, the heat pump can be configured to optimize time of energy consumption by preheating water during daytime, storing the hot water in the high temperature storage tank and thereafter releasing the water upon demand, e.g., for heating and showers. In another example, a significant amount of the thermal energy is consumed for air conditioning (A/C) purposes, such that by storing hot and cold water in the system can control the usage time of the stored energy, without being restricted to the available sunny daily hours.

In some embodiments, the system described herein is part of a thermal microgrid. The thermal microgrid is an intelligent system that efficiently manages all thermal energy needs within a building or facility, including generation, storage, control, and consumption. In the present example, the thermal microgrid may consist of multiple heat pump units operating on the same site, integrated with the buildings' existing heating and cooling systems and their connection to the grid. The control system architecture is designed with a distributed and hierarchical structure. Each module may have its own local programmable logic controller (PLC) system responsible for keeping safe operation and changing the operational mode, while a higher-level control system will create the strategy, assign “tasks” to each module, and coordinate the whole system, including synchronization with existing chillers and heaters.

In the foregoing discussion, the energy that is used to run the heat pump is either grid energy or renewable energy that is utilized when it is generated. In alternative embodiments, energy may be stored as electricity in a battery, such as a lithium battery (fed from a photovoltaic unit and/or grid). The stored energy may be used to operate the heat pump. As the heat pump draws energy from at least one of these sources, it is converted into thermal storage which is used for daily storage and distributed to consumers. In addition to stored energy, the heating user loads may also have other sources of heat, including cogeneration/heat recovery (e.g., from showers water) and gas burner, e.g., a biogas or any other caloric gas. When the heat pump is integrated with other heat sources, the heat pump can use most of the excess solar energy time because it has a high coefficient of performance (COP), while the other alternative heat sources are used according to energy availability and other considerations.

1. A system for storing thermal energy, the system comprising
at least a pair of thermal storage tanks, wherein at least one of said pair of thermal storage tanks is a high temperature tank and at least one another of said pair of thermal storage tanks is a low temperature tank, wherein each of the thermal storage tanks is configured for holding therein a thermal storage substance having a predetermined heat capacity; and
at least one refrigeration cycle for operation of a vapor compression cycle, wherein the high temperature tank and the low temperature tank are each thermally coupled to the refrigeration cycle and configured such that during operation of the vapor compression cycle heat is withdrawn from the thermal storage substance in the low temperature tank to the refrigeration cycle, and simultaneously heat is withdrawn from the at least one refrigeration cycle to the thermal storage substance in the high temperature tank.

2. The system according to claim 1, wherein the thermal storage substance is water.

3. The system according to claim 1, wherein the thermal storage substance is a phase change material.

4. The system according to claim 3, wherein the phase change material in the high temperature tank is configured to store latent heat at a temperature of up to approximately 54-59° C., and the phase change material in the low temperature tank is configured to store latent heat at a temperature down to approximately 2-7° C.

5. The system according to claim 1, further comprising an ambient heat exchanger, and one or more valves configured to thermally connect each of the thermal storage tanks to the ambient heat exchanger and to thermally disconnect each of the thermal storage tanks from the refrigeration cycle, wherein the one or more valves are controllable to switch the system from a closed loop system, in which both thermal storage tanks exchange heat with only the refrigeration cycle, to an open loop system, in which at least one of the thermal storage tanks exchanges heat with ambient atmosphere.

6. The system according to claim 1, further comprising an ambient heat exchanger and one or more valves configured to thermally connect the refrigeration cycle to the ambient heat exchanger, wherein the one or more valves are controllable to switch the system from a closed loop system, in which a refrigerant exchanges heat only with the thermal storage tanks, and an open loop system, in which the refrigerant exchanges heat with ambient environment.

7. The system according to claim 1, wherein at least a pair of thermal storage tanks comprises three or more sets of thermal storage tanks, wherein each set of thermal storage tanks contains a thermal storage substance that is configured to store thermal energy at a different temperature.

8. The system according to claim 1, wherein the at least one refrigeration cycle comprises two refrigeration cycles arranged in a cascade, whereby one refrigeration cycle is thermally coupled to the low temperature tank, a second refrigeration cycle is thermally coupled to the high temperature tank, and the two refrigeration cycles are thermally connected to each other via an intermediate temperature thermal storage tank functioning as a heat exchanger.

9. The system according to claim 1, further comprising a heat balancing conduit for directly transferring thermal energy from the high temperature cycle (tank) to the low temperature cycle (tank).

10. The system according to claim 1, further comprising heat distribution members configured to distribute stored thermal energy to user loads directly or indirectly for heating and cooling.

11. The system according to claim 1, further comprising a battery for storing electrical energy generated by the renewable energy source.

12. The system according to claim 1, wherein the refrigeration cycle comprises a compressor, evaporator, expander, and condenser arranged in sequence; wherein the condenser is configured to exchange heat with the high temperature tank, and the evaporator is configured to exchange heat with the low temperature tank.

13. A method of storing thermal energy, the method comprising
operating a vapor compression cycle on a system according to claim 1;
during operation of the vapor compression cycle withdrawing heat from the thermal storage substance in the low temperature tank to the refrigeration cycle, and simultaneously withdrawing heat from the at least one refrigeration cycle to the thermal storage substance in the high temperature tank; and
storing the withdrawn heat as thermal energy in the respective thermal storage substances.

14. The method according to claim 13, wherein the storing step comprises storing the thermal energy in a sensible manner.

15. The method according to claim 13 wherein the storing step comprises storing the thermal energy in a latent heat manner.

16. The method according to claim 13, wherein the thermal storage substances comprise fluids.

17. The method according to claim 13, wherein the thermal storage substances comprise or consist of phase change materials.

18. The method according to claim 13, wherein the system further comprises an ambient heat exchanger and one or more valves configured to thermally connect each of the thermal storage tanks to the ambient heat exchanger and to thermally disconnect each of the thermal storage tanks from the refrigeration cycle, the method further comprising:
operating the one or more valves to thereby connect at least one of the thermal storage tanks to the ambient heat exchanger, to thereby convert the system from a closed loop state to an open loop state; and operating the vapor compression cycle when the system is in the open loop state to thereby charge one tank while maintaining the other tank idle.

19. The method according to claim 13, further comprising operating the vapor compression cycle in reverse when the system is an open loop heat state to thereby generate flexible storage capacity in one of the temperature tanks while the other temperature tank remains idle.

20. The method according to claim 13, wherein the flexible storage capacity is stored in a sensible manner.

21. The method according to claim 13, further comprising discharging the thermal energy generated with flexible storage capacity to a user load and subsequently discharging the thermal energy generated at the other temperature tank to the same user load.

22. The method according to claim 13, wherein the system further comprises an ambient heat exchanger and one or more valves configured to thermally connect the refrigeration cycle to the ambient heat exchanger, and the method further comprises: operating the one or more valves to open a thermal connection between the refrigeration cycle and an ambient heat exchanger, to thereby convert the system from a closed loop to an open loop system; and operating the vapor compression cycle in an open loop system.

23. The method according to claim 13, further comprising discharging stored thermal energy from the low temperature tank to at least one cold user load and discharging stored thermal energy from the high temperature tank to at least one hot user load.

24. The method according to claim 23, wherein the discharging step comprises discharging thermal energy to both the cold and hot user loads independently of each other.

25. The method according to 23, further comprising performing the discharging step while the system is operating to generate additional thermal storage.
